(19) United States
(12) Patent Application Publication
(10) Pub. No.: US 2016/0229227 A1
(43) Pub. Date: Aug. 11, 2016

(54) WHEEL ASSEMBLY WITH TWIST CAP HUB COVER

(71) Applicant: JAT Wheels, Inc., Alhambra, CA (US)

(72) Inventor: Tom Luo, Alhambra, CA (US)

(21) Appl. No.: 14/617,946

(22) Filed: Feb. 10, 2015

(51) Int. Cl. B60B 7/00; B60B 7/06; B60B 7/08; B60B 7/04

(52) U.S. Cl. CPC B60B 7/0013; B60B 7/04; B60B 7/066; B60B 7/08

(57) ABSTRACT

A wheel assembly with a twist cap hub cover forms a secure attachment with a wheel. The wheel has a wheel hub and a body portion. The twist cap hub cover is configured to form a secure, coaxial relationship with the wheel hub. The twist cap hub cover alternatively covers different sets of openings in the wheel, such that air flow is allowed to enter behind the body portion of the wheel, and a decorative effect is created from the interaction between the twist cap hub cover and the covered and uncovered sets of wheel openings. A disc retains a tensioning member on a disc inner surface. The tensioning member abuts against a hub inner surface. This creates a coaxial, snug fit. A ring encircles the disc. The ring has projections that rotatably cover the first or second set of openings in the body portion of the wheel.

### FIELD OF THE INVENTION

The present invention relates generally to a wheel assembly with a twist cap hub cover. More so, the wheel assembly provides a twist cap hub cover that utilizes spring tension to form a snug, coaxial relationship with a wheel hub, and includes spaced-apart projections that selectively mate with a first and second set of spaced-apart openings in the wheel to enable the passage of air through the openings and create a decorative effect.

### BACKGROUND OF THE INVENTION

Typically, a vehicle uses wheels that are generally circular components, and that are intended to rotate on an axial bearing. Wheels, in conjunction with axles, allow heavy objects to be moved easily facilitating movement or transportation while supporting a load, or performing labor in machines. The wheel has a face that forms a protective barrier against dirt and moisture. However, the face can also restrict air flow that is useful for cooling down the mechanisms behind the wheel, such as the brakes.

The hub is the central point of the wheel structure where all dynamic loads transfer from the tire-wheel system through the spokes into the bicycle frame. The hub handles tremendous static and dynamic loads created by the road, the rider and the tension of the spokes. The hub is usually covered to restrict dirt or water from entering into the inner mechanisms of the wheel, including the brakes.

The wheels of some vehicles are fitted with decorative plates covering the hubs of the wheels, one of the purposes of which plates is to avoid the wheel-mounting bolts becoming dirty. As the vehicle is running, the wheels are rotated accordingly and the design or the shape of the wheels may not be recognized at all. There is very little decorative effect from the rotation of the wheel. Therefore, a means or method is desired to have the decorated wheel recognized.

Other proposals have involved hub covers that have coaxial relationships with hubs and the face of the wheel. The problem with these devices is that they easily disengage from the wheel hub, do not enable the free flow of air behind the wheel, and do not create an ornamental effect to the wheel as a whole.

Thus, an unaddressed need exists in the industry to address the aforementioned deficiencies and inadequacies. Even though the above cited hub caps meets some of the needs of the market, a twist cap hub cover that securely fits into a wheel hub and overlays alternate spacing in the wheel to enable air flow and create a decorative effect is still desired.

### SUMMARY OF THE INVENTION

The present invention is directed to a wheel assembly with a twist cap hub cover that forms a secure attachment with a wheel hub in a wheel. The wheel may include a vehicle wheel having a wheel hub, a body portion, a rim, and a plurality of lug holes. The twist cap hub cover is configured to form a secure, coaxial relationship with the wheel hub. The twist cap hub cover is sized and dimensioned to press into the wheel hub with a small inward force and a twisting motion. The twist cap hub cover has a plurality of spaced-apart projections that substantially match, and alternatively cover a first and second set of spaced-apart openings in the wheel. In this manner, air flow is allowed to enter behind the face of the wheel, and a decorative effect is created while the wheel is rolling from the interaction between the spaced-apart projections and the covered and uncovered sets of spaced-apart openings in the wheel.

The twist cap hub cover comprises a central disc and a plurality of spaced-apart projectiles that extend radially from the disc. The disc has a tensioning member that engages a groove in a hub inner surface of the wheel hub. The tensioning member creates a tension force that helps retain the disc inside the wheel hub. The disc may be slightly rotated, or twisted into the wheel hub to create sufficient torque to fasten the disc into place. The force generated by the tensioning member abutting against a groove in the hub inner surface creates a spring tension that securely presses the twist cap hub cover into the wheel hub. Thus, a snug, coaxial relationship is formed between the twist cap hub cover and the wheel hub.

The plurality of spaced-apart projections extend radially from the disc. The projections are configured to be shaped and dimensioned substantially the same as a first set and a second set of spaced-apart openings in the face of the wheel. The spaced-apart openings may be disposed on the perimeter region of the wheel hub. The projections of the twist cap hub cover selectively mate with either the first set or second set of spaced-apart openings in the wheel. In this manner, when the first set of openings are covered by the projections, the second set of openings remain uncovered, and thus air is allowed to flow behind the body portion of the wheel. Furthermore, as the wheel rotates, the alternating pattern of covered and uncovered spaced-apart openings creates a decorative effect.

One objective of the present invention is to provide a twist cap hub cover that securely sits inside a wheel hub through a tension force.

Another objective is to create a disc that has a decorative outer surface that substantially matches the color and pattern of the wheel.

Another objective is to enable detachment of the disc and ring from the wheel hub though a small pulling force and a slight twisting motion.

Yet another objective is to alternatively cover the first or second set of spaced-apart openings with the spaced-apart projections.

Yet another objective is to provide an inexpensive twist cap hub cover that can be used universally with any number of wheels.

Yet another objective is to provide a wheel assembly that can be operated with no tools and minimal skill set.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a perspective view of an exemplary wheel assembly with twist cap hub cover, in accordance with an embodiment of the present invention;

FIG. 2 illustrates a front view of an exemplary ring, in accordance with an embodiment of the present invention;

FIG. 3 illustrates a rear view of an exemplary ring, in accordance with an embodiment of the present invention;

FIG. 4 illustrates a perspective front view of an exemplary ring and a perspective front view of an exemplary disc, in accordance with an embodiment of the present invention;

FIG. 5 illustrates a perspective rear view of an exemplary ring and a perspective side view of an exemplary disc, in accordance with an embodiment of the present invention;

FIG. 6 illustrates a perspective front view of an exemplary wheel with a wheel hub and a first and second set of spaced-apart openings, in accordance with an embodiment of the present invention;

FIG. 7 illustrates a perspective front view of an exemplary twist cap hub cover overlaying a first set of spaced-apart openings from a first position, in accordance with an embodiment of the present invention;

FIG. 8 illustrates a perspective front view of an exemplary twist cap hub cover overlaying a second set of spaced-apart openings from a second position, in accordance with an embodiment of the present invention;

FIG. 9 illustrates a front view of an exemplary ring with triangle shaped projections, in accordance with an embodiment of the present invention; and

FIG. 10 illustrates a front view of an exemplary ring with a plurality of spaced-apart inverted projections having inverted triangle shaped projections, in accordance with an embodiment of the present invention.

Like reference numerals refer to like parts throughout the various views of the drawings.

### DETAILED DESCRIPTION OF THE INVENTION

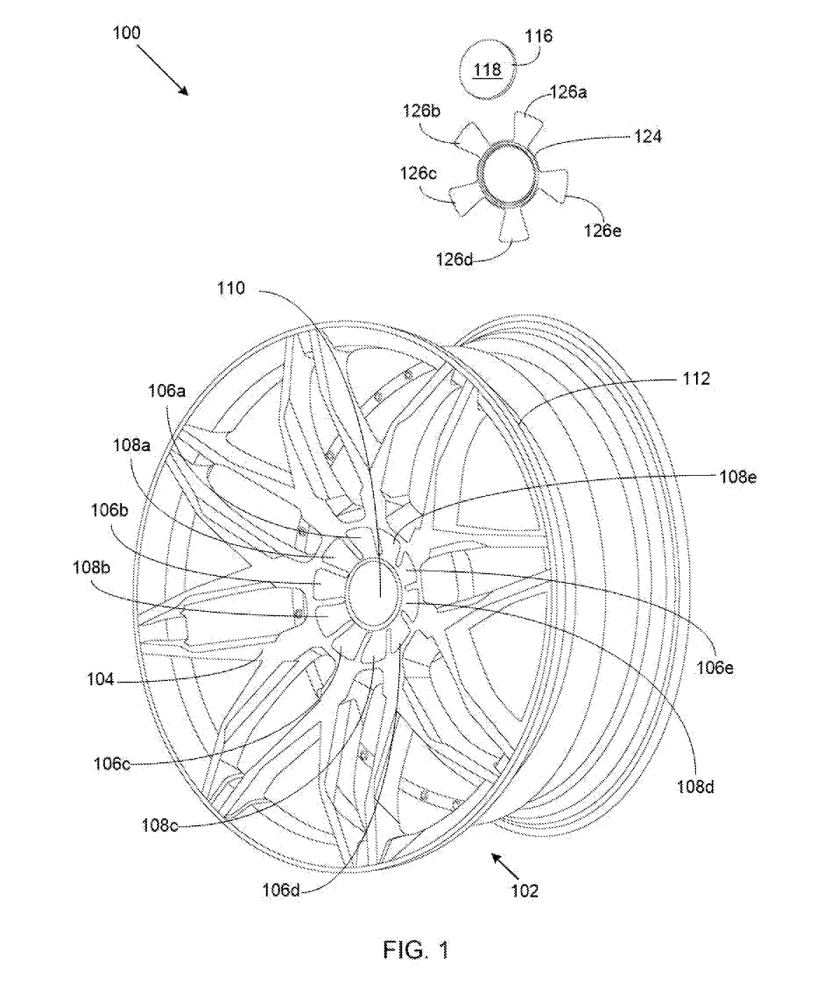

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “first,” “second,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

At the outset, it should be clearly understood that like reference numerals are intended to identify the same structural elements, portions, or surfaces consistently throughout the several drawing figures, as may be further described or explained by the entire written specification of which this detailed description is an integral part. The drawings are intended to be read together with the specification and are to be construed as a portion of the entire “written description” of this invention as required by 35 U.S.C. §112.

In one embodiment of the present invention presented in FIGS. 1-10, a wheel assembly 100 with twist cap hub cover is configured to enhance operational function and decorative aspects of a wheel 102. The assembly 100 forms a coaxial relationship with a wheel hub 110. The assembly 100 enables airflow to pass through the wheel 102, while also creating a decorative effect on the wheel 102. Furthermore, the assembly 100 may be used universally with any number of wheels 102 and wheel hubs 110 known in the art. Though, in one embodiment, the wheel 102 is custom designed for the assembly 100.

As illustrated in FIG. 1, the assembly 100 comprises a wheel 102. The wheel 102 is defined by a body portion 104, a wheel hub 110, and a rim 112. The body portion 104 of the wheel 102 includes the face that extends from the rim 112 to the wheel hub 110. The body portion 104 may have various decorative features, including, gaps, spokes, and various textures. Suitable materials for the wheel 102 may include, without limitation, aluminum, metal alloys, and steel. The body portion 104 includes a first set of spaced-apart openings 106a-e and a second set of spaced-apart openings 108a-e proximally disposed to the wheel hub 110. In one embodiment, five spaced-apart openings make up each of the first and second set of spaced-apart openings 106a-e, 108a-e. Though any number of openings 106a-e, 108a-e may be used in other embodiments. Furthermore, a plurality of lug holes 130 may be visible through the openings 106a-e, 108a-e.

The wheel hub 110 is defined by a hub inner surface 114. The first set of spaced-apart openings 106a-e and the second set of spaced-apart openings 108a-e have a substantially triangular shape. Though in other embodiments, any number of shapes may be used. The openings 106a-e, 108a-e may also have various depths and depending on whether the wheel 102 is rim-centric, or hub-centric.

In the present assembly 100, the wheel hub 110 forms the foundation for supporting the functional and decorative features discussed. The wheel hub 110 is defined by a hub inner surface 114. The hub inner surface 114 comprises a groove. The groove may be circular and have a depth that is sufficient to receive a similarly shaped and sized hub cover. Those skilled in the art will recognize that the wheel hub 110 forms the central point of the body portion 104 of the wheel 102 where all dynamic loads transfer from the tire-rim interaction through the body portion 104 of the wheel 102. The wheel hub 110 handles tremendous static and dynamic loads created by the road, the vehicle operator, and the tension of the spokes. In the present assembly 100, the wheel hub 110 serves chiefly, to coaxially mate with a disc 116.

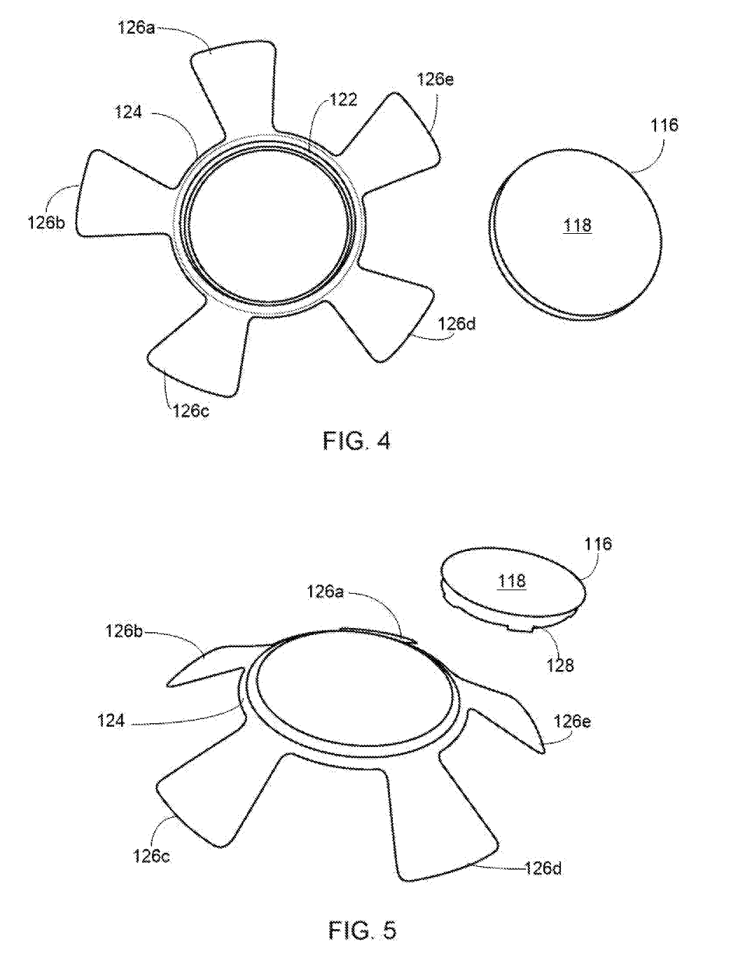

Turning now to FIGS. 4 and 5, the disc 116 is disposed in a generally snug, coaxial relationship with the wheel hub 110. The disc 116 is sized and dimensioned to press into the wheel hub 110 with a small inward force and a twisting motion. However, tension forces, which are explained below, also contribute to retaining the disc 116 in the wheel hub 110. The disc 116 is defined by a disc outer surface 118 and a disc inner surface 120. The disc outer surface 118 may include a decorative aspect, including, without limitation, colors that match the body portion 104 of the wheel 102, textures, patterns, and text.

The disc inner surface 120 comprises a bracket 128. The bracket 128 helps to retain a tensioning member 122. The tensioning member 122 may include a circular spring that, when compressed inwardly, creates a tension force. Specifically, the tensioning member 122 is configured to create an outward tension force against the hub inner surface 114. In one embodiment, the tensioning member 122 is a circular spring that sits in the bracket 128. The circular spring is biased to create an outward tension force. The tensioning member 122 has a diameter that is approximately the same as the groove in the hub inner surface 114. In this manner, when the disc inner surface 120 is pressed into the wheel hub 110, the tensioning member 122 presses outwardly and retains the disc 116 in the wheel hub 110.

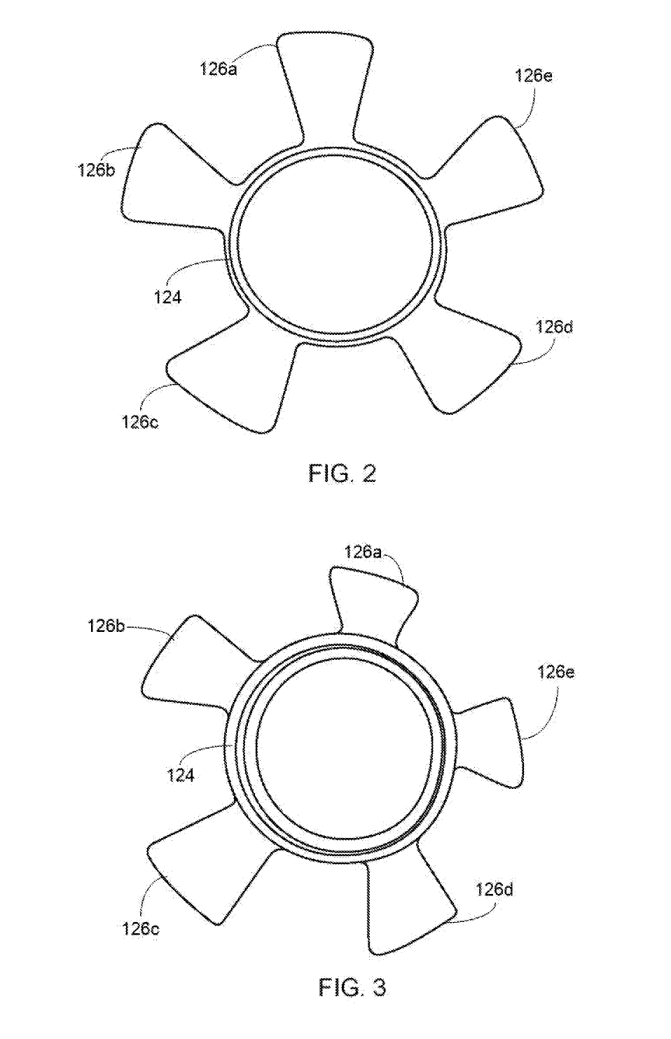

As referenced in FIGS. 2 and 3, the assembly 100 further comprises a ring 124. The ring 124 is disposed to detachably encircle the disc 116. Thus, the ring 124 forms an outer circumference to the disc 116 for both functional and decorative purposes. In one embodiment, the ring 124 and the disc 116 remain attached during 124 operation. Though they may be separated for repairs or cleaning In one embodiment, the ring 124 attaches to the disc 116 by through a frictional snap lock connection with the bracket 128 in the disc inner surface 120. However, the ring 124 may attach to the bracket 128 through other fastening mechanisms, including, without limitation, magnets, screws, frictional engagement, and adhesives.

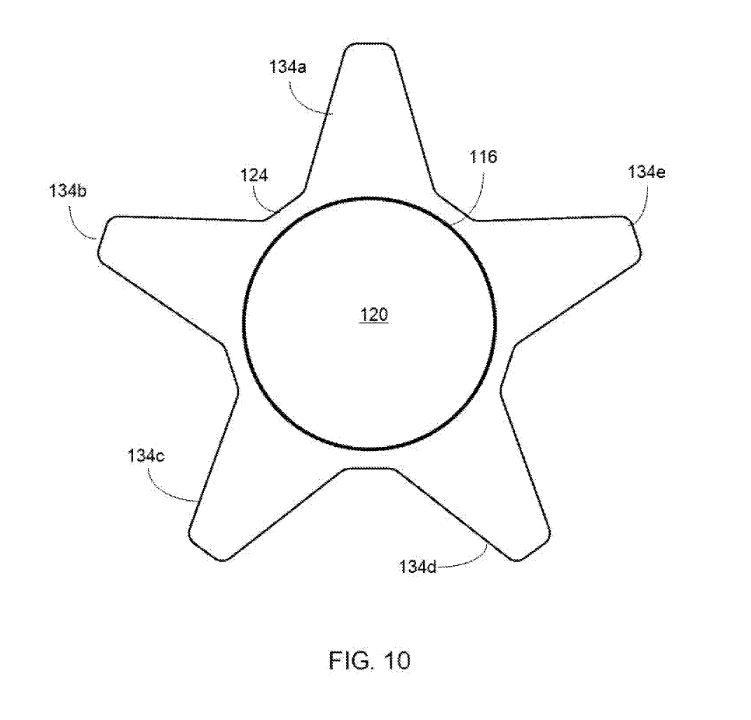

In some embodiments, the ring 124 may be defined by a plurality of spaced-apart projections 126a-e. The plurality of spaced-apart projections 126a-e are configured to have substantially the same shape as the first and second sets of spaced-apart openings 106a-e, 108a-e. In one embodiment, the projections 126a-e are substantially triangular and angled outwardly to conform to the shapes of the first and second sets of openings 106a-e, 108a-e, and the body portion 104 of the wheel 102. The projections 126a-e are configured to align and mate with either the first or second set of spaced-apart openings 106a-e, 108a-e in the body portion 104 of the wheel 102. In one embodiment, five spaced-apart projections 126a-e extend radially from the ring 124. Though any number of projections 126a-e may be used in other embodiments. As shown in FIG. 10, inverted projections 134a-e may be used.

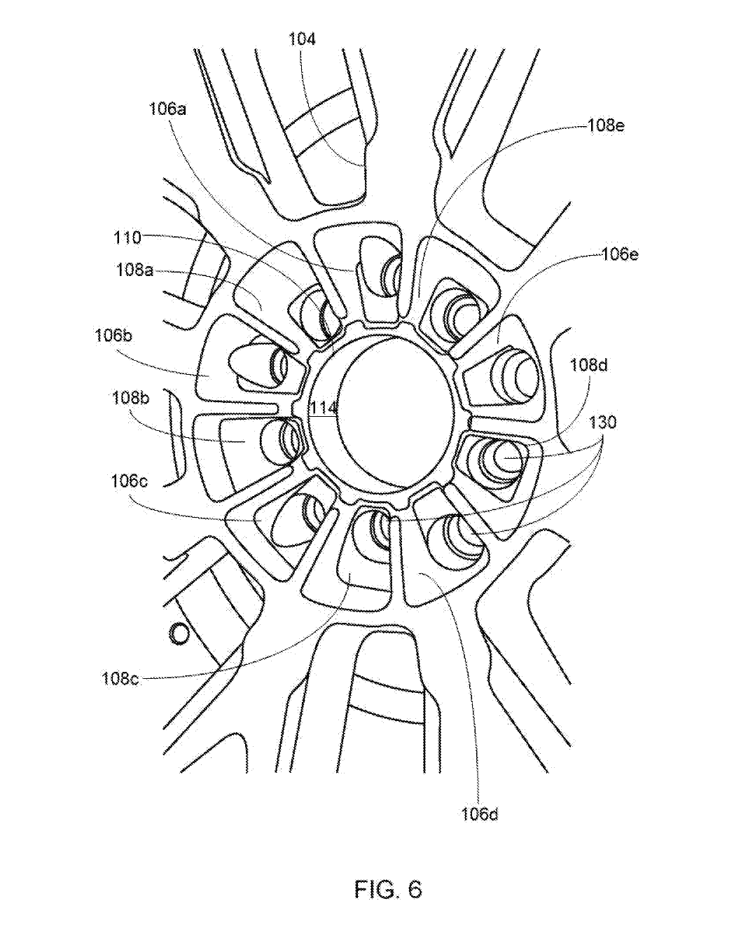

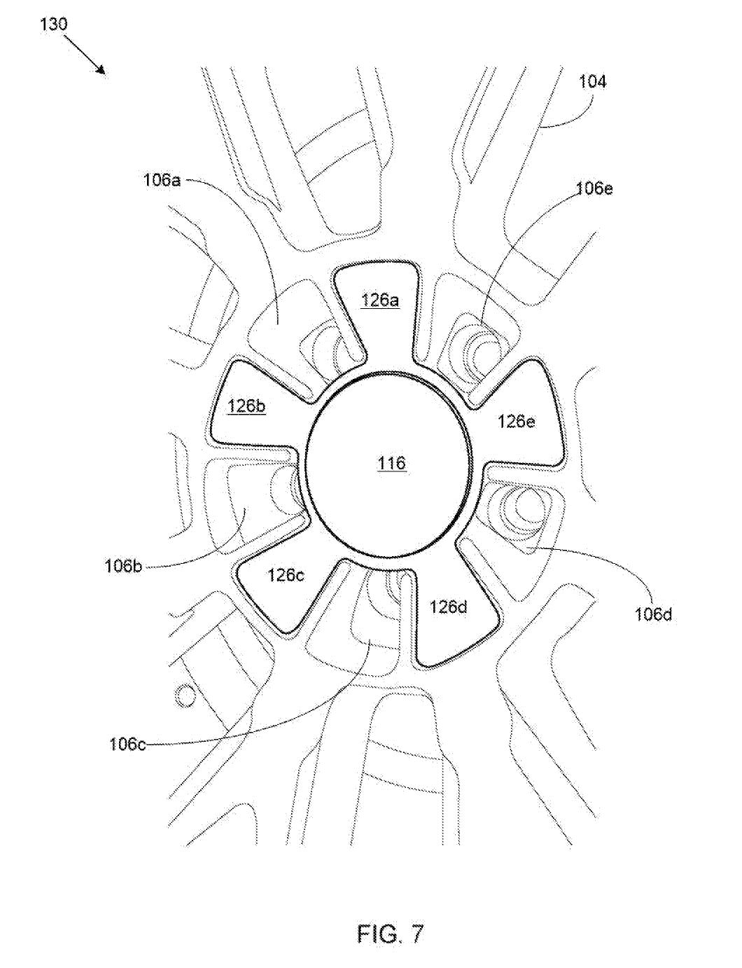

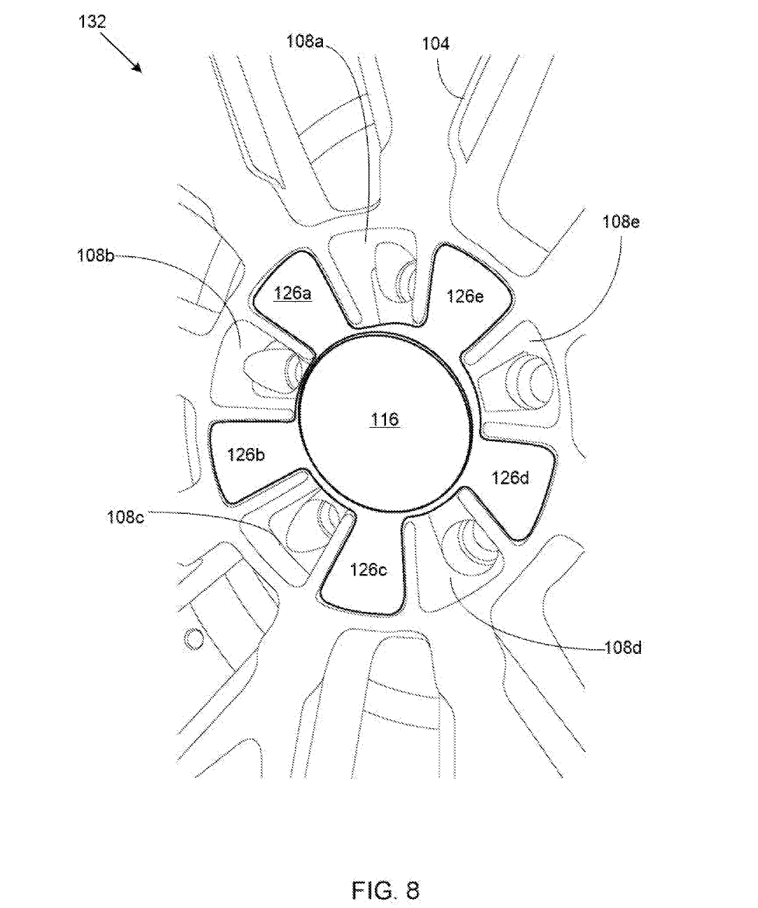

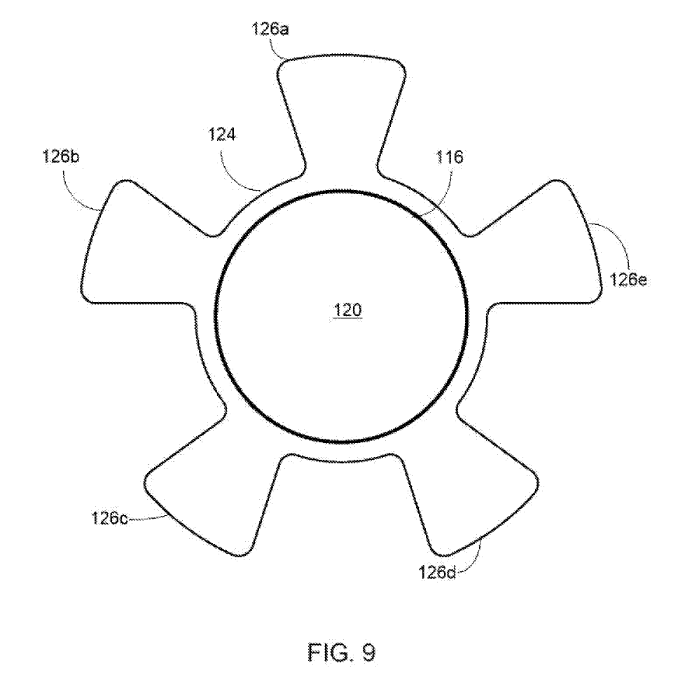

As referenced in FIG. 6, the plurality of spaced-apart projections 126a-e are configured to cover the first set of spaced-apart openings 106a-e from a first position 130, and cover the second set of spaced-apart openings 108a-e from a second position 132. The ring 124 rotatably moves between the first position 130 and the second position 132 (See FIGS. 7 and 8). In one embodiment, the attached disc 116 and ring 124 are positioned, such that the projections 126a-e engage the first set of openings 106a-e, while leaving the second set of openings 108a-e remain uncovered (FIG. 7). This enables air to flow behind the body portion 104 of the wheel 102 to cool down the brakes and the mechanical components therein. Furthermore, while the wheel 102 rotates during 124 operation, the alternating pattern of covered and uncovered openings 106a-e, 108a-e near the wheel hub 110 create a unique decorative effect.

As referenced in FIG. 4, the disc 116 and ring 124 may be detached from the first set of spaced-apart openings 106a-e by pulling the disc 116 out of the wheel hub 110 (overcoming the tension force of the tensioning member 122), twisting the projections 126a-e into alignment with the second set of spaced-apart openings 108a-e, and finally pressing the disc 116 into the wheel hub 110. This alternative covering 124 of the first and second set of openings 106a-e, 108a-e is easily performed without requiring special tools or skill sets.

As discussed above, the plurality of spaced-apart projections 126a-e of the ring 124 have a generally triangular shape (FIG. 9). However, in one alternative embodiment, referenced in FIG. 10, the ring 124 comprises a plurality of spaced-apart inverted projections 134a-e. These inverted projections 134a-e have a generally inverted triangle shape. The spaced part openings 106a-e, 108a-e of the wheel 102 are also shaped to accommodate the spaced-apart inverted projections 134a-e, accordingly.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What I claim is:

1. A wheel assembly for covering a portion of a wheel with a twist cap hub cover, the wheel assembly comprising:
a wheel, the wheel defined by a body portion and a wheel hub, the body portion having a first set of spaced-apart openings and a second set of spaced-apart openings proximally disposed to the wheel hub, the wheel hub having a hub inner surface;
a disc, the disc disposed in a coaxial relationship with the wheel hub, the disc defined by a disc outer surface and a disc inner surface, the disc inner surface having a tensioning member, the tensioning member configured to create a tension force against the hub inner surface; and
a ring, the ring disposed to detachably encircle the disc, the ring defined by a plurality of spaced-apart projections, the plurality of spaced-apart projections configured to have substantially the same shape as the first and second sets of spaced-apart openings,
the plurality of spaced-apart projections further configured to cover the first set of spaced-apart openings from a first position, the plurality of spaced-apart projections further configured to cover the second set of spaced-apart openings from a second position,
whereby the ring rotatably moves between the first position and the second position.

2. The assembly of claim 1, wherein the wheel is a vehicle wheel.

3. The assembly of claim 1, wherein the wheel further includes a rim and a plurality of lug holes.

4. The assembly of claim 1, wherein the body portion of the wheel is defined by decorative gaps and recurring patterns.

5. The assembly of claim 1, wherein the hub inner surface comprises a groove, the groove configured to mate with the tensioning member of the disc inner surface.

6. The assembly of claim 1, wherein the tensioning member forms a substantially circular shape.

7. The assembly of claim 1, wherein the ring is disposed to position between the disc inner surface and the tensioning member.

8. The assembly of claim 1, wherein the tensioning member is biased to exert an outward tension force against the hub inner surface.

9. The assembly of claim 1, wherein the first set of spaced-apart openings and the second set of spaced-apart openings have a substantially triangular shape.

10. The assembly of claim 1, wherein the plurality of spaced-apart projections have a substantially triangular shape.

11. The assembly of claim 1, wherein the plurality of spaced-apart projections are configured to extend radially from the ring.

12. The assembly of claim 1, wherein the plurality of spaced-apart projections are oriented to form an angle.

13. A wheel assembly for covering a portion of a wheel with a twist cap hub cover, the wheel assembly comprising:
a disc, the disc defined by a disc outer surface and a disc inner surface, the disc inner surface having a tensioning member, the tensioning member configured to create an outward tension force; and
a ring, the ring disposed to detachably encircle the disc, the ring defined by a plurality of spaced-apart projections, the plurality of spaced-apart projections configured to extend radially from the ring.

14. The assembly of claim 13, further including a wheel, the wheel defined by a body portion and a wheel hub, the body portion having a first set of spaced-apart openings and a second set of spaced-apart openings proximally disposed to the wheel hub, the wheel hub having a hub inner surface;

15. The assembly of claim 14, wherein the disc is disposed in a coaxial relationship with the wheel hub.

16. The assembly of claim 15, wherein the tensioning member is configured to create a tension force against the hub inner surface.

17. The assembly of claim 16, wherein the first set of spaced-apart openings and the second set of spaced-apart openings have a substantially triangular shape.

18. The assembly of claim 17, wherein the plurality of spaced-apart projections are configured to have substantially the same shape as the first and second sets of spaced-apart openings.

19. The assembly of claim 18, wherein the plurality of spaced-apart projections further configured to cover the first set of spaced-apart openings from a first position, the plurality of spaced-apart projections further configured to cover the second set of spaced-apart openings from a second position,

20. The assembly of claim 19, wherein the whereby the ring rotatably moves between the first position and the second position.
